(19) United States
(12) Patent Application Publication
(10) Pub. No.: US 2005/0152279 A1
(43) Pub. Date: Jul. 14, 2005

(54) Downlink power control in wireless communications networks and methods

(76) Inventors: Brett L. Robertson, Mundelein, IL (US); Ramnath V. Dalal, Chicago, IL (US); Ramakrishna V. Yellapantula, Grayslake, IL (US)

Correspondence Address: MOTOROLA INC, 600 NORTH US HIGHWAY 45, ROOM AS437, LIBERTYVILLE, IL, 60048-5343, US

(21) Appl. No.: 10/755,917

(22) Filed: Jan. 13, 2004

(51) Int. Cl. H04L 12/26; H04B 7/216

(52) U.S. Cl. 370/252; 370/320; 370/342

(57) ABSTRACT

A method in a wireless communications device, for example, 3GPP W-CDMA wireless mobile user equipment, including receiving a slot-structured signal having a dedicated control channel and a dedicated data channel, estimating a first SIR (410) on the dedicated control channel, estimating a second SIR (420) on the dedicated data channel if a symbol on the dedicated data channel contains data, weighting the first and second SIR estimates (430), and summing (440) the first SIR and the second SIR estimates after weighting.

### FIELD OF THE DISCLOSURE

The disclosure relates generally to wireless communications, and more particularly to downlink power control in the presence of time varying interference in wireless communications networks, for example, in 3GPP W-CDMA communications networks, including methods in wireless communications devices connected to the network.

### BACKGROUND OF THE DISCLOSURE

In W-CDMA communications systems, for example, 3^{rd} Generation Partnership Project (3GPP) Universal Mobile Telephone System (UMTS) wireless communications systems, mobile user equipment (UE) transmits a power control command to the network for use in controlling transmission power. The power control command is based on an inner-loop power control algorithm that estimates a Signal-to-Interference Ratio (SIR) at the output of the rake receiver.

It is known to estimate the signal-to-interference ratio (SIR) based on the downlink Dedicated Physical Control Channel (DPCCH), which is part of the Dedicated Physical Channel (DPCH). The DPCH is, however, subject to interference from the Primary and Secondary Synchronization Channels, since the codes used on the Synchronization Channels are not orthogonal to those of the DPCH and the Synchronization Channels are transmitted at power levels typically much higher than that of the power-controlled DPCH. How Primary and Secondary Synchronization Channel interference affects the SIR measurement depends the frame offset between the Dedicated Physical Channel (DPCH) and the Common Pilot Channel (CPICH). Interference on the DPCH results in inaccuracies in the estimation of the SIR.

In 3GPP, the interleaving of transport channels onto the DPCH is not highly randomized. Thus the grouping of transport channel data tends to be bunched together instead of randomly and widely dispersed. If the corresponding portion of each slot is corrupted by interference, for example, by cross-correlation of the Primary or Secondary Synchronization Channels and the DPCH, the corrupted transport channel data is less likely to be decoded successfully. This also affects the accuracy of the SIR estimation.

In 3GPP Downlink Power Control (DLPC), the UE requests the base station (BS) to lower the transmit level of the downlink DPCH as low as possible while maintaining the base station prescribed Block Error Rate (BLER). This algorithm is based on the estimated SIR and the measured BLER of specific transport channels. Inaccuracies in the SIR estimate may thus cause the UE to request a lower power level than required to meet the requested BLER.

In applications where Blind Rate Detection (BRD) is employed, for example, in some 3GPP UMTS networks, BRD may compound problems discussed above. BRD is a method where the UE determines the combination of formats sent on all transport channels without guidance from the BS. The UE, however, cannot be sure that erroneous decoding on the transport channels is due to an exceedingly low SIR or to the absence of data, for example, lack of data resulting from a discontinuous data transmission (DTX).

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary wireless communications device in a wireless communications network.

FIG. 2 is an exemplary rake receiver.

FIG. 3 is an exemplary downlink signal structure.

FIG. 4 is an exemplary schematic process diagram.

### DETAILED DESCRIPTION

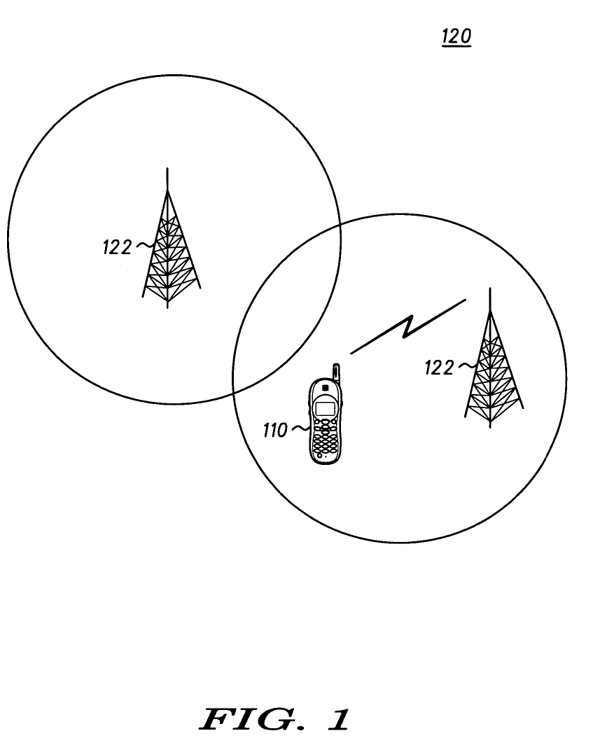

In FIG. 1, a wireless communications device 110 in a wireless communication network 120, for example, a 3^{rd} Generation Partnership Project (3GPP) Universal Mobile Telephone System (UMTS) W-CDMA wireless communications network, periodically transmits power control commands to network base stations 122. Each base station uses the SIR information to allocate downlink transmission power resources. The SIR may also be used for base station selection.

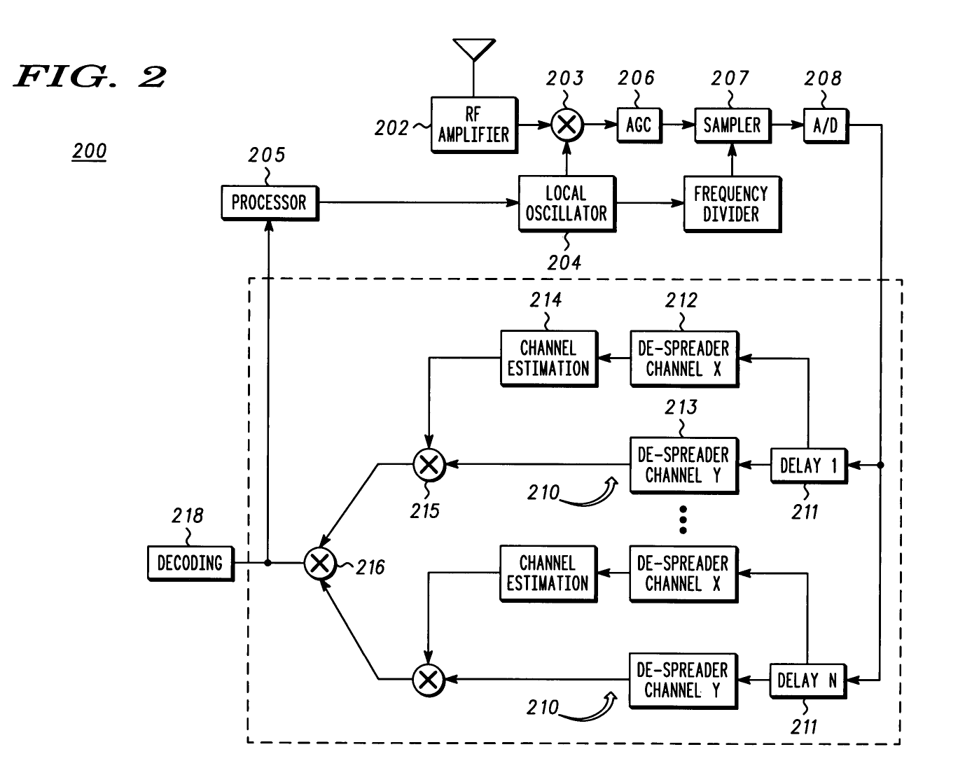

The power control command is based on a power control algorithm, residing on the wireless device, that estimates a Signal-to-Interference Ratio (SIR) based on rake receiver outputs as is known generally in the art. FIG. 2 is an exemplary partial schematic block diagram of a rake receiver 200. An amplifier 202 amplifies the received signal before a mixer 203 combines the amplified signal with a signal from a local oscillator 204, which is controlled by a processor 205. The mixed signal is subject to gain control by automatic gain controller (AGC) 206 before sampling at 207 and digitization at analog to digital converter 208. The digitized signal is provided to a plurality of parallel rake fingers 210 after corresponding delays 211. Each finger 210 includes corresponding first and second channel de-spreaders 212, 213, one of which is coupled to a channel estimator 214 before summation at a summer 215. The rake finger outputs are summed at summer 216 and then decoded at 218.

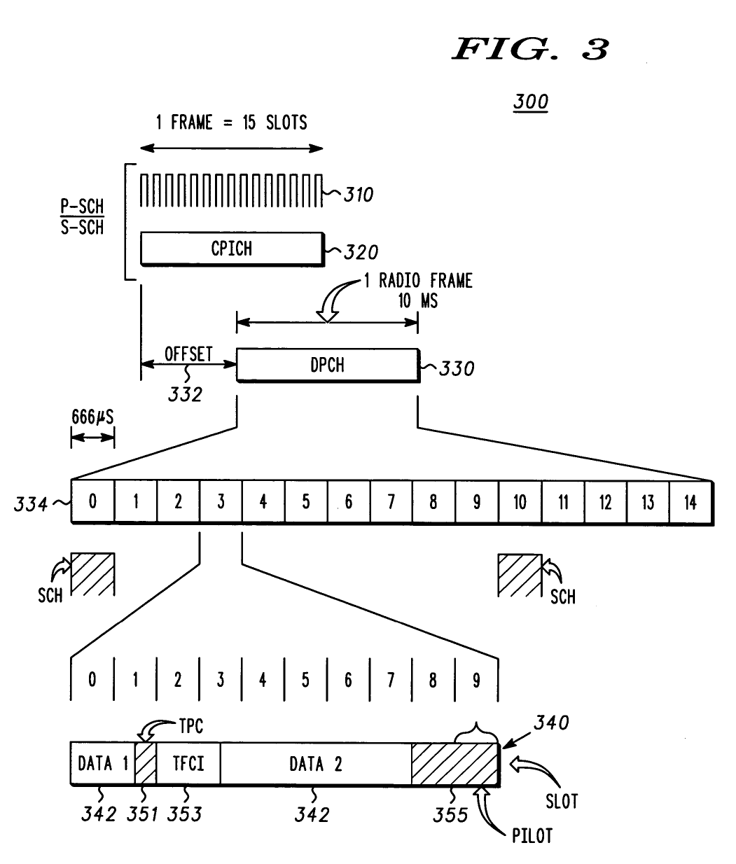

The received signal generally includes multiple channels. These channels may be separate physical channel and/or separate logical channels, all of which may have different symbol rates and/or spread factors depending upon the particular communications protocol to which the signal conforms. FIG. 3 is an exemplary UMTS downlink signal structure 300 including primary and secondary synchronization channel (P-SCH & S-SCH) 310, a Common Pilot Channel (CPICH) frame 310 and a Dedicated Physical Channel (DPCH) frame 330, which is offset from the CPICH frame by a frame offset 332. In FIG. 3, each DPCH frame comprises 15 slots (0-14) indicated collectively at 334. Each slot includes generally data and control channels. In FIG. 3, the exemplary slot 340 includes a Dedicated Physical Data Channel (DPDCH) comprising data blocks 342, and a Dedicated Physical Control Channel (DPCCH) comprising a Transmit Power Control (TPC) 351, a Transport Format Combination Indicator (TFCI) 353, which indicates the combinations of different transport channels, and Pilot information 355. FIG. 3 also illustrates the alignment of the synchronization signal (SCH) 312 relative to the slot 342. Where the SHC signal 312 aligns with the channel in the slot depends on the frame offset 332 discussed above. Other communications protocols have other signaling structures.

SIR estimation is based generally on signals at the rake finger output. Instantaneous power measurements are obtained on a slot-by-slot basis, e.g., every slot, wherein the signal and noise components of the SIR are obtained from filtered estimates of signal and noise power. In one embodiment, the signal amplitude is estimated from data at the output of a data rate processor (DRP) embodying the functionality of the processing block 211-216 in FIG. 2, which is based upon both CPICH [aux pilot] and DPCH data [main data].

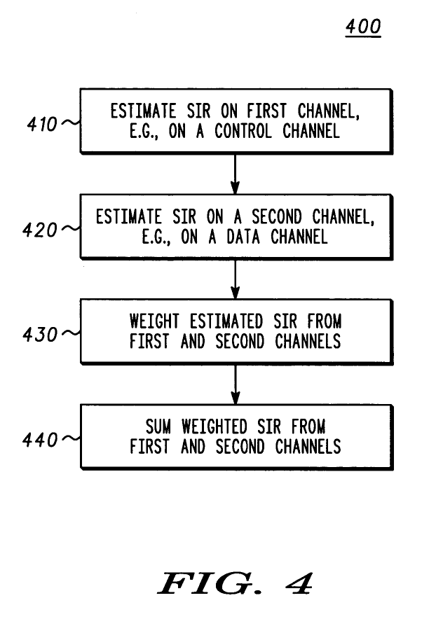

In one embodiment the estimated SIR is a composite SIR based on a first SIR computed on a first channel and a second SIR computed on a second channel. In the process diagram 400 of FIG. 4, at block 410, a first SIR is estimated on the first channel and at block 420 a second SIR is estimated on the second channel. The result is indifferent to the ordering of the SIR estimations and in some embodiments both SIRs are estimated simultaneously.

In one embodiment, the first SIR is estimated on a dedicated data channel, for example, on a Dedicate Physical Date Channel (DPDCH) of the type discussed above in connection with the exemplary signal structure of FIG. 3, and the second SIR is estimated on a dedicated control channel, for example, the Dedicated Physical Control Channel (DPCCH) discussed above in FIG. 3. Thus in one embodiment, the SIR is a linear combination of the SIR on the DPCCH and on the DPDCH as follows:
DPCH_{—}SIR=p*DPCCH_{—}SIR+(1−p)*DPDCH_{—}SIR Eq. (1)

Estimation of the SIR on a data channel requires distinguishing signal, e.g., symbols having data, from noise, since the signal is required to estimate the signal power component of the SIR. In some applications, the estimation of SIR on the data channel may be further complicated by interruptions in signal transmissions, for example, discontinued transmissions (DTX) during signal fading.

In one embodiment, SIR is estimated on a data channel only if the signal on the channel satisfies a condition, i.e., if the received symbols contain data. In one embodiment, the determination is made whether a data channel symbol contains data by estimating the amplitude of the symbol, for example, based on bit amplitude. The estimated signal amplitude is compared to a reference.

In one embodiment, the reference is obtained by averaging symbol amplitudes known to contain data, for example, upon successfully decoding received symbols. In the exemplary UMTS downlink signal structure 300 in FIG. 3, the reference amplitude is obtained by decoding the data transport channels, e.g., upon successful completion of a cyclical redundancy check (CRC). In one embodiment, the mean signal amplitude of each transport channel is calculated and conditionally updates an average if the transport channel had a properly decoded CRC (Cyclical Redundancy Check). However, this amplitude can change over a large dynamic range due to the amount of interference on the system (# of other users) and the effects of downlink power control.

Since the DPCH_SIR is a ratio of signal to interference energy:
DPCH_{—}SIR(t)=DPCH_signal_energy(t)/DPCH_interference_energy(t) Eq. (2)
According to the relation in Eq. (2), if interference is increased, the signal energy must also be increased by a multiplicative factor to maintain a constant DPCH_SIR. The network can command the UE to maintain an exceedingly low or high block error rate (BLER) target. In 3GPP, for example, these values can range from 100% to 0.00005%. At these exemplary extremes, the DPCH_SIR required to obtain a high BLER target can be quite small, for example 0 dB or less. Conversely, the DPCH_SIR required to obtain a low BLER target can be comparatively large, for example, 10-15 dB.

The transport channel is characterized by several parameters, including block length. Since downlink power control is based on a block error rate, the block error probability must be calculated. The block error probability computation required knowledge of the block length. If a bit error has a probability of “p” and a block is N bits long, then the probability of a block error (assuming the occurrence of a bit error is an independent random variable) may be expressed as:
(1−(1−p)\hat{ }N) Eq. (3)
Eq. (3) is indicative of the probability of 1 or more bits being in error out of N, where: “p” is the probability of a bit error, 0<=p<=1, “1−p” is the probability of a bit not being in error, and “(1−p)\hat{ }N” is the probability of N consecutive bits not being in error. Since the probability of a bit error is widely described as a function of the DPCH_SIR, the probability of a block error may be expressed as follows:
(1−(1−f(DPCH_SIR))\hat{ }N) Eq. (4)

So for a fixed DPCH_SIR, changing the value of the N will change the probability of a block error.

Another transport channel parameter is the coding type. There are three types of coding allowed: turbo coding, convolutional coding, and no coding. Each of coding types has a different error rate performance as they implement different decoding techniques, for example, MAP, MLSE, HARD DECISION, etc., with differing amounts of error correction.

Depending on the block length, coding type, and rate matching parameters, the UE may be required to puncture or repeat the data of each decoded stream in differing amounts. If a particular transport channel was punctured, this means that a certain percentage of the DL data was not transmitted. This will degrade decoding performance as the UE then insert zeros to compensate for this missing data and rely more on the error-correcting capabilities of the channel decoder to account for the lack of data. If a particular transport channel was repeated, certain symbols in the downlink were transmitted multiple times. This improve decoding performance of the corresponding transport channel as there are some symbols which have multiple (at least twice) redundancy relative to the reliability of the original data set.

In another embodiment, the reference is obtained from a using a DPCCH_PWR_OFFSET. In one embodiment, for example, a candidate level for the DPDCH amplitude is generated using measured amplitude of the DPCCH, e.g., using TPC and PILOT information, and applying the DPCCH_POWER_OFFSET. This candidate amplitude can then be used to generate a threshold by which each DPDCH symbol can be compared to determine existence or absence of signal energy.

In FIG. 4, at block 430, in some embodiments, the SIR components computed on the control channel and on the data channel are weighted before summing. In Equation (1) above, for example, the DPCCH_SIR component is weighted by a factor “p”, and the DPDCH_SIR component is weighted by a factor “1−p”. Other weighting schemes may be used alternatively. In one embodiment, where weighting is applied to the SIR estimates, the weighting factor is based, for example, on the amount of data in each slot and/or the confidence of the SIR estimate. At block 440, the weighted SIR estimates are added.

In implementations where the DRP includes digital gain stages, for example, after each of the despreaders 212, 213 in FIG. 2, the gain applied at each stage and estimated amplitudes of both CPICH and DPCCH are required to estimate the threshold for determining signal vs. noise at the output of the combiner (216).

While the present disclosure and what is considered presently to be the best mode thereof have been described in a manner that establishes possession by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

1. A method in a wireless communications device, the method comprising:
receiving a signal having first and second channels;
estimating a first SIR on a first channel of the signal received;
estimating a second SIR on a second channel of the signal received;
combining the first SIR and the second SIR.

2. The method of claim 1, the first channel is a dedicated data channel, estimating the first SIR on the dedicated data channel.

3. The method of claim 2, the second channel is a dedicated control channel, estimating the second SIR on the dedicated control channel.

4. The method of claim 2, combining the first SIR and the second SIR includes weighting the first SIR and weighting the second SIR, and summing the weighted first SIR and the weighted second SIR.

5. The method of claim 1, combining the first SIR and the second SIR includes weighting the first SIR and weighting the second SIR, and summing the weighted first SIR and the weighted second SIR.

6. The method of claim 1, estimating the SIR on the first channel based on symbols containing data.

7. The method of claim 6, determining whether a symbol on the first channel contains data by estimating signal amplitude for the symbol and comparing the estimated signal amplitude to a reference.

8. The method of claim 7, comparing the estimated signal amplitude to the amplitude threshold includes comparing the estimated signal amplitude to an average of amplitudes of properly decoded transport channels.

9. A method in a method in a wireless communications device, comprising:
estimating SIR for a received data channel if a signal on the data channel satisfies a condition;
estimating SIR for a control channel;
combining the SIR for the control channel with the SIR for the data channel.

10. The method of claim 9, weighting the SIR for the control channel and the SIR for the data channel.

11. The method of claim 10, weighting the SIR for the control channel and the SIR for the data channel based on an amount of data and based on energy associated with the control channel and data channel.

12. The method of claim 9, determining whether the signal on the data channel satisfies the condition by comparing an amplitude of the signal to a reference amplitude, the reference amplitude obtained by averaging signal amplitudes from properly decoded data channels.

13. The method of claim 9, determining whether the signal on the data channel satisfies the condition by comparing a symbol amplitude on the data channel with a reference.

14. A method in a wireless communications device, the method comprising:
receiving a slot-structured signal having a dedicated control channel and a dedicated data channel;
estimating a first SIR on the dedicated control channel;
estimating a second SIR on the dedicated data channel only if a symbol on the dedicated data channel contains data;
weighting the first and second SIR estimates;
summing the first SIR and the second SIR estimates after weighting.

15. The method of claim 14, determining whether a symbol on the dedicated data channel contains data by comparing a signal amplitude for the symbol with a reference.

16. The method of claim 14,
estimating the first SIR for multiple slots on the dedicated control channel based on filtered estimates of signal and noise power;
estimating a second SIR for multiple slots on the dedicated data channel based on filtered estimates of signal and noise power.

17. The method of claim 16,
estimating the second SIR on the dedicated data channel only if a signal on the dedicated data channel satisfies a condition.

18. The method of claim 17,
determining whether the signal in the dedicated data channel satisfies the condition by comparing an amplitude of the signal to a reference.

19. The method of claim 18, determining the reference by averaging amplitudes of properly decoded signals on a transport channel.

20. The method of claim 18, determining the reference by averaging amplitudes of properly decoded signals on an associated dedicated pilot channel.
